(19) United States
(12) Patent Application Publication
(10) Pub. No.: US 2006/0169855 A1
(43) Pub. Date: Aug. 3, 2006

(54) Base for a vehicle onboard monitoring device

(75) Inventor: Yi-Kung Chen, Taipei (TW)

Correspondence Address: NIKOLAI & MERSEREAU, P.A., 900 SECOND AVENUE SOUTH, SUITE 820, MINNEAPOLIS, MN, 55402, US

(73) Assignee: Modas Shing Company Ltd., Taipei (TW)

(21) Appl. No.: 11/047,028

(22) Filed: Jan. 31, 2005

(51) Int. Cl. F16M 11/00

(52) U.S. Cl. 248/200

(57) ABSTRACT

A base for a vehicle onboard monitoring device includes a hollow frame defined therein a space for receiving therein the monitoring device and having a first pair of cutouts and a second pair of cutouts and a connecting plate. The connecting plate has two ears to selectively extend into the first pair of cutouts and the second pair of cutouts such that changing orientation of the connecting plate to allow the connecting plate to be connected to a different side face of the vehicle is able to maintain an image right-side-up in the monitoring device.

### BACKGROUND OF THE INVENTION

1. Field of the Invention

The present invention relates to a base for a monitoring device, and more particularly to a vehicle onboard monitoring device base to allow positioning switch of the monitoring device while preventing the image in the monitoring device being the wrong side up.

2. Description of Related Art

Normally, a monitoring device mounted on a vehicle is used to monitor the rear of the vehicle so that when the vehicle is backing up, the driver is able to monitor the rear of the vehicle at all times and thus accidents are avoided. Once the monitoring device is mounted on a rear side of the vehicle via a base, the monitoring device is adjusted to clearly present any image in the rear of the vehicle. However, when the driver is changing the position of the monitoring device, the base that goes with the monitoring device has to be changed accordingly, otherwise the image presented in the monitoring device will be up-side-down. Because the base is not damaged and still workable, replacing the existing base with a new base for the monitoring device to only change the shooting angle of the monitoring device is a waste of money and labor involved.

To overcome the shortcomings, the present invention tends to provide an improved base for a vehicle onboard monitoring device to mitigate the aforementioned problems.

### SUMMARY OF THE INVENTION

The primary objective of the present invention is to provide a base for a vehicle onboard monitoring device to allow the monitoring device of a vehicle to have its position changed relative to the vehicle while maintaining the image right-side-up.

In order to accomplish the aforementioned objective, the base of the present invention includes a hollow frame adapted to receive therein a monitoring device and having two pairs of cutouts respectively defined in a first side face and a second side face and the second side face and a third side face of the frame and a connecting plate having two ears respectively and selectively inserted into the first pair of cutouts and the second cutouts such that shooting angle of the monitoring device is changed via changing orientation of the connecting plate and thus images in the monitoring device are maintained the right-side-up.

Other objects, advantages and novel features of the invention will become more apparent from the following detailed description when taken in conjunction with the accompanying drawings.

### BRIEF DESCRIPTION OF THE DRAWINGS

FIG. 1 is a perspective view showing the base of the present invention with a monitoring device received inside the base;

FIG. 2 is an exploded perspective view of the base;

FIG. 3 is a schematic view showing the application of the base via the connecting plate;

FIG. 4 is a schematic view showing that the shooting angle of the monitoring device is changed via changing the orientation of the connecting plate; and

FIGS. 5 and 6 are schematic views showing the possible locations of the monitoring device on a vehicle.

### DETAILED DESCRIPTION OF THE PREFERRED EMBODIMENT

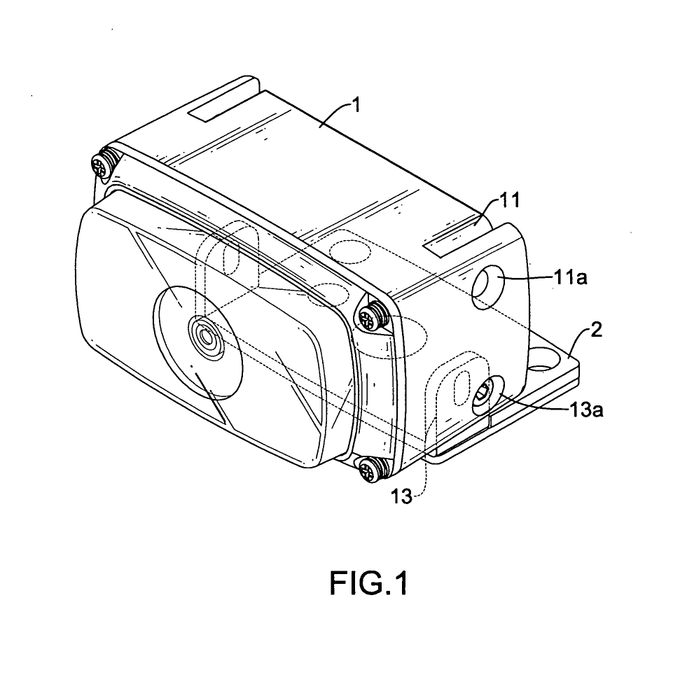

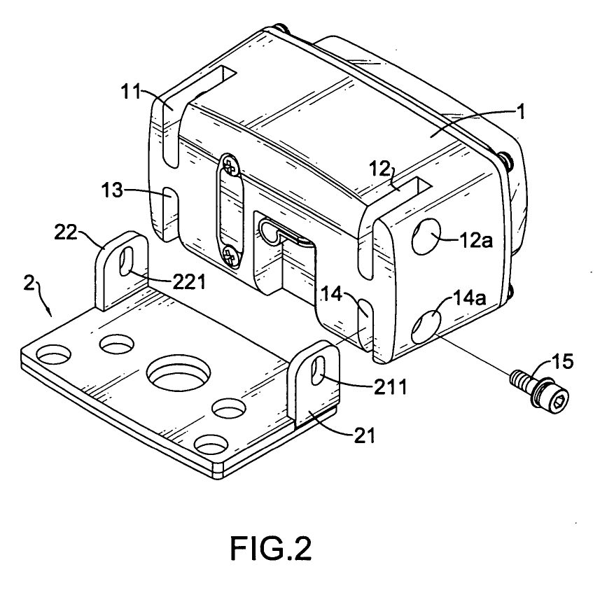

With reference to FIGS. 1 and 2, the base for a vehicle onboard monitoring device and in accordance with the present invention includes a frame (1) and a connecting plate (2).

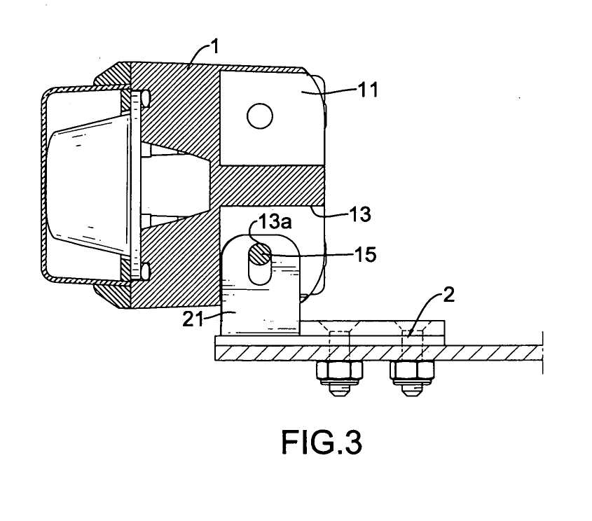

The frame (1) is defined with a space therein for receiving therein a monitoring device (not numbered) and has two pairs of cutouts, a first pair of cutouts (11,12) and a second pair of cutouts (13,14). The first pair of cutouts (11,12) is defined in two adjacent side faces, i.e. the first side face and the second side face of the frame (1). The second pair of cutouts (13,14) is defined in the second side face and a third side face of the frame (1) such that each of the first pair of cutouts (11,12) and the second pair of cutouts (13,14) are provided with an L shape in appearance. Each of the first pair of cutouts (11,12) and the second pair of cutouts (13,14) may be provided with a rectangular shape in cross section as shown in FIG. 3. Further, each of the first pair of cutouts (11,12) is provided with a first securing hole (11a, 12a) in communication with a corresponding one of the first pair of cutouts (11,12) and each of the second pair of cutouts (13,14) is provided with a second securing hole (13a,14a) in communication with a corresponding one of the second pair of cutouts (13,14). Screws (15) are provided to each of the first pair of cutouts (11,12) and the second pair of cutouts (13,14).

The connecting plate (2) is provided with two ears (21,22) formed on a side face of the connecting plate (2) to be oppositely located on top of the side face. Each of the two ears (21,22) is provided with a through hole (211,221) defined through the corresponding one of the two ears (21,22) to selectively correspond to the first pair of cutouts (11,12) and the second pair of cutouts (13,14).

When the frame (1) is combined with the connecting plate (2), each of the two ears (21,22) is inserted into a corresponding one of the first pair of cutouts (11,12) or the second pair of cutouts (13,14) to align the through holes (211,221) with the first securing holes (11a, 12a) of the first pair of cutouts (11,12) or the second securing holes (13a, 14a) of the second pair of cutouts (13,14). Then the screws (15) are inserted into the aligned first securing holes (11a,12a) and the through holes (211,221) or the second securing holes (13a,14a) and the through holes (211,221) to secure the connecting plate (2) to the frame (1).

After the assembly of the base of the present invention, the base is able to be directly mounted on a top face of the chassis of the vehicle to support the monitoring device as shown in FIG. 3. It is noted that the screws (15) are inserted into the second securing holes (13a,14a) of the second pair of cutouts (13,14) (only (13a) is shown in this drawing) and the frame (1) is on top of the connecting plate (2).

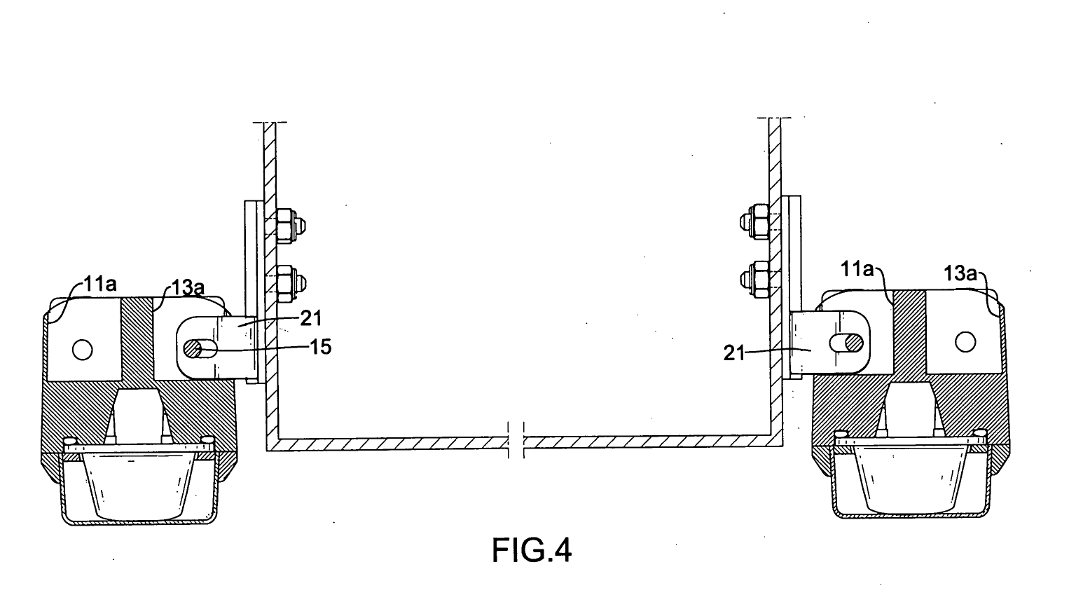

With reference to FIG. 4, it is noted that the user of the base of the present invention is able to alternatively apply the base to the left or to the right of the vehicle via changing the orientation of the connecting plate (2). Changing the employment of the screws (15) from the combination of the through holes (211,221) and the second securing holes (13a,14a) to the combination of the through holes (211,221) and first securing holes (11a, 12a) changes the orientation of the connecting plate (2) while maintaining the monitoring device inside the frame (1) unchanged such that the image is kept right-side-up.

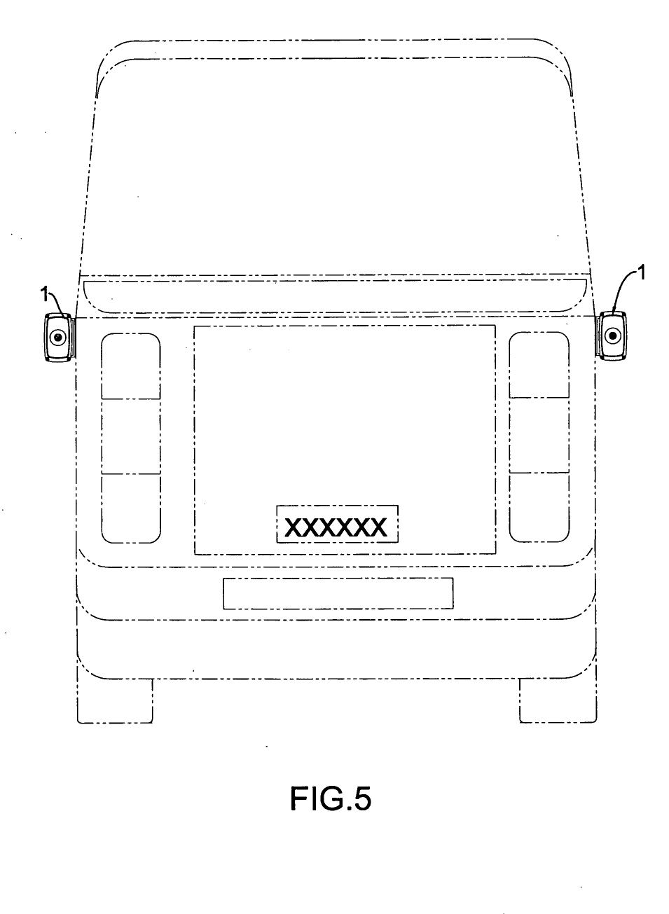

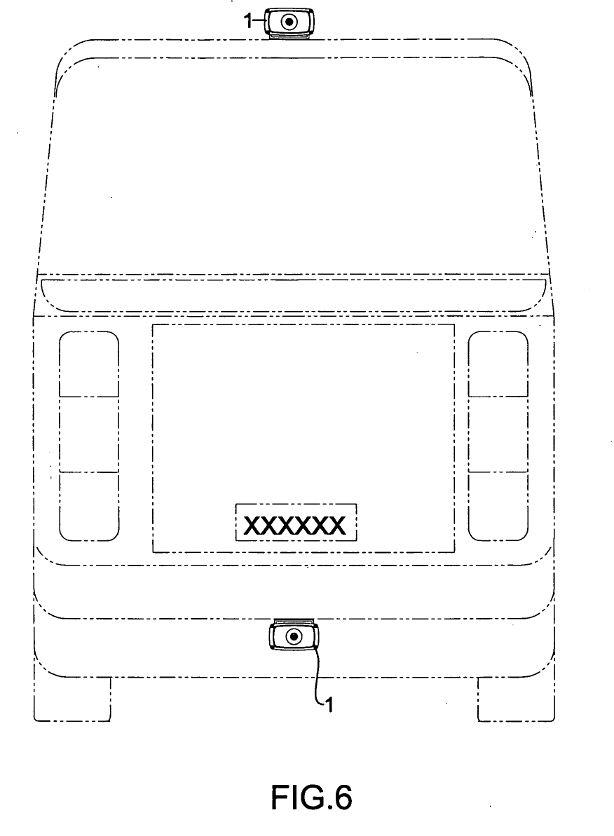

With reference to FIGS. 5 and 6, with the combination of the frame (1) and the connecting plate (2), the base allows the user to either mount the monitoring device to the center, to the left or to the right of a vehicle.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A base for a vehicle onboard monitoring device, the base comprising:
a hollow frame defining therein a space for receiving therein the monitoring device and having a first pair of cutouts defined in a first side face and a second side face adjacent to the first side face of the frame and a second pair of cutouts defined in the second side face and a third side face adjacent to the second side face; and
a connecting plate having two ears respectively mounted on a side face of the connecting plate to selectively extend into the first pair of cutouts and the second pair of cutouts such that changing orientation of the connecting plate to allow the connecting plate to be connected to a different side face of the vehicle is able to maintain an image right-side-up in the monitoring device.

2. The base as claimed in claim 1, wherein the frame further has first securing holes each in communication with a corresponding one of the first pair of cutouts and second securing holes each in communication with a corresponding one of the second pair of cutouts, each of the two ears has a through hole to selectively align with a corresponding one of the first pair of cutouts and the second pair of cutouts to allow screws to extend into the aligned through holes of the ears and the first pair of cutouts or the second pair of cutouts so as to allow the orientation change of the connecting plate for connection to the different side face of the vehicle.
